(19) United States
(12) Patent Application Publication
(10) Pub. No.: US 2022/0373216 A1
(43) Pub. Date: Nov. 24, 2022

(54) FLEXIBLE AIR DUCT WINDING AND UNWINDING DEVICE FOR AIR SUPPLY

(71) Applicant: HUANENG POWER INTERNATIONAL., INC. SHANGHAI SHIDONGKOU FIRST POWER PLANT, Shanghai (CN)

(72) Inventors: Xiao ZHANG, Shanghai (CN); Haifeng GUAN, Shanghai (CN); Yanglin AI, Shanghai (CN); Mo WANG, Shanghai (CN)

(21) Appl. No.: 17/447,432

(22) Filed: Sep. 12, 2021

(30) Foreign Application Priority Data
May 19, 2021 (CN) 202110544171.0

(51) Int. Cl. F24F 13/02; B66D 1/24; B66D 1/60

(52) U.S. Cl. CPC F24F 13/0272; F24F 13/0218; F24F 13/0209; B66D 1/24; B66D 1/60; F23J 11/02

(57) ABSTRACT

The present invention relates to a flexible air duct winding and unwinding device for air supply, including an air duct reel assembly, a flexible air duct, two reel seats, a rotating air inlet assembly and a rotating drive assembly for driving the rotation of the air duct reel assembly; the air duct reel assembly includes a reel body, a reel air duct shaft, and a reel rotating shaft, the rotating air inlet assembly includes an inlet air duct, a fixed air duct and a rotating air duct rotatably inserted in the fixed air duct, the air outlet end of the inlet air duct is connected with the air inlet end of the fixed air duct, the air outlet end of the rotating air duct is fixedly connected with the reel air duct shaft, and the output shaft of the rotating drive assembly is fixedly connected with the reel rotating shaft.

### CROSS-REFERENCE TO RELATED APPLICATIONS

The present application claims priority to Chinese Patent Application No. 202110544171.0 filed on May 19, 2021, which is incorporated herein by reference in its entirety.

### TECHNICAL FIELD

The present invention relates to the field of air supply device, in particular to a flexible air duct winding and unwinding device for air supply.

### BACKGROUND ART

In industrial production sites, air supply devices or air transporting devices are often in need to meet the air exchange requirements of equipment and personnel, or to transport clean air to the site to disperse toxic and harmful gases, or directly discharge unwanted gases out of the site through the transport pipeline, so as to ensure that the air in the equipment mounting area and the working area of the personnel is qualified. Such ventilation or air supply devices and air supply pipelines are used more often, and various kinds of flexible air ducts or rigid air ducts are commonly fixed and arranged in industrial production sites to play a role of ventilation and air transport. In the actual application site, there is often the need to supply air or transport air to mobile equipment, in a short distance method, a flexible air duct is adopted to move along with the movement of mobile equipment, the flexible air duct is often hanged or placed on the bottom ground or equipment, some other mobile equipment and the air supply equipment are placed at locations with a height difference, resulting in that the air duct is arranged to be inclined or vertical, the mobile equipment or the location to be mounted needs to perform vertical or inclined movement, if the air supply duct is hanged and directly dragged, it easily leads to leakage due to damage of the pipeline, the main reason is that when the flexible air duct for ventilation is in the hanging process or is directly dragged, this is a kind of disorderly placement, the flexible air duct is easily twisted and knotted or folded in this disorderly placement process, resulting in deformation of the flexible air duct, this situation will affect the ventilation area of the air duct, increase the resistance of gas transportation, and easily damage the gas transportation pipeline, making the service life of the gas transportation pipeline shorter; in addition, the distance of air supply using the above method is shorter, and if the distance is longer, no corresponding method is available at present.

### SUMMARY OF THE INVENTION

The object of the present invention is to overcome the above shortcomings in the prior art and provide a flexible air duct winding and unwinding device for air supply.

The object of the present invention is realized through the following technical solution:

a flexible air duct winding and unwinding device for air supply includes an air duct reel assembly, a flexible air duct, two reel seats, a rotating air inlet assembly and a rotating drive assembly for driving the rotation of the air duct reel assembly, the air duct reel assembly includes a reel body, a reel air duct shaft, and a reel rotating shaft, wherein an end face of one end of the reel body is formed with an air inlet slot and is fixedly installed with the reel air duct shaft, the reel air duct shaft is hollow inside to form an air duct and is communicated with the air inlet slot, the end face of the other end of the reel body is fixedly provided with the reel rotating shaft, the reel seat includes a bracket and a bearing seat arranged on the bracket, the reel air duct shaft is in rotatable connection with a bearing seat on the reel seat, the reel rotating shaft is in rotatable connection with the bearing seat on another reel seat, the flexible air duct is wound on a side wall of the reel body, the side wall of the reel body is formed with an air duct connection port, one end of the air duct connection port is communicated with the air inlet slot, and the other end is communicated with the air inlet of the flexible air duct.

The rotating air inlet assembly includes an inlet air duct, a fixed air duct and a rotating air duct rotatably inserted in the fixed air duct, wherein the air outlet end of the inlet air duct is connected with the air inlet end of the fixed air duct, and the air outlet end of the rotating air duct is fixedly connected with the reel air duct shaft, and the output shaft of the rotating drive assembly is fixedly connected with the reel rotating shaft.

Preferably, the air duct reel assembly further includes an air duct positioning assembly, the air duct positioning assembly includes a steel wire rope and a plurality of air duct positioning members, the air duct positioning members are arranged on the steel wire rope at intervals, the air duct positioning member includes an air duct hoop sleeve, a connecting plate and a rope hoop, the rope hoop is fixedly sleeved on the steel wire rope, the air duct hoop sleeve is fixedly sleeved on the flexible air duct, one end of the connecting plate is fixedly connected with the rope hoop, and the other end is fixedly connected with the air duct hoop sleeve.

Preferably, a side wall of the reel body is formed with a rope slot for placing the steel wire rope, the initial end of the rope slot is provided with a fixed head, and the fixed head is fixedly connected with the initial end of the steel wire rope.

Preferably, the rotating drive assembly includes an electric motor, a gear reducer and a coupling, an output shaft of the electric motor is connected with an input end of the gear reducer, and an output shaft of the gear reducer is fixedly connected with the reel rotating shaft by means of a coupling.

Preferably, the rotating drive assembly further includes a hysteresis coupling, and an output shaft of the electric motor is connected with an input end of the gear reducer by means of the hysteresis coupling.

Preferably, the winding and unwinding device further includes an air duct outlet assembly, and the air outlet of the flexible air duct is communicated with the air inlet of the air duct outlet assembly.

Preferably, the air duct outlet assembly includes a fixed platform, an outlet air duct, and a fixed support, the fixed support is fixedly arranged on the fixed platform, the outlet air duct is fixedly connected with the fixed support, and an air inlet of the outlet air duct is communicated with the air outlet of the flexible air duct.

Preferably, a plurality of rolling bearings are arranged between the rotating air duct and the fixed air duct, and the two sides of the rolling bearings are provided with oil seals and oil seal pressing plates.

Preferably, a gas seal ring and a gas seal pressing plate for fixing the gas seal ring are arranged between the circumference of the air inlet end of the rotating air duct and the inner side wall of the fixed air duct.

Preferably, the air duct reel assembly further includes two mounting platforms, the rotating air inlet assembly is arranged on one mounting platform, and the rotating drive assembly is arranged on the other mounting platform.

Preferably, the fixed platform is provided with a steel wire rope fixed end, and the tail end of the steel wire rope is fixedly connected with the fixed end of the steel wire rope.

Compared with the prior art, the present invention has the following advantages:

(1) The air duct reel assembly, the rotating air inlet assembly and the rotating drive assembly of the present invention operate in cooperation to realize the automatic winding and unwinding of the flexible air duct on the reel body, and effectively realize the requirements of mobile air supply, with a safe and reliable device structure and long service life.

(2) The flexible air duct, the air duct positioning assembly and the reel body structure are used to achieve the effective winding and automatic winding and unwinding of the flexible air duct on the reel body, accumulation or twisting and knotting and folding of the flexible air duct due to redundancy will not appear, thereby effectively improving the safety performance and stability during use of the flexible air duct, and the connecting line between the air supply position and air supply point position can be vertical or inclined, and can also be arranged horizontally, therefore the present invention has the characteristics of good adaptability to the site environment and a wide range of application scenarios.

(3) The rotating drive assembly of the present invention uses a hysteresis coupling to achieve constant torque output, thereby facilitating forward rotation, rotation stopping and reverse rotation of the reel body in different use scenarios, and being convenient and simple to use with high safety performance.

(4) The present invention is easy to install and implement, has low requirements on site environment and less maintenance workload, can operate continuously and stably for a long time, has high efficiency of air supply to the air duct, and has less resistance to air supply.

(5) The fixed air duct and the rotating air duct of the present invention have stable rotating cooperation and good sealing performance, and are conducive to the air inlet effect and stability.

### BRIEF DESCRIPTION OF THE DRAWINGS

FIG. 1 is schematic diagram of an overall structure of the present invention;

FIG. 2 is schematic diagram of an overall structure of the present invention;

FIG. 3 is a sectional schematic diagram of the structure of a rotating air inlet assembly of the present invention;

FIG. 4 is a structural schematic diagram of a rotating drive assembly of the present invention;

FIG. 5 is a structural schematic diagram of a reel body of the present invention;

FIG. 6 is a schematic diagram of a partial structure of the reel body of the present invention;

FIG. 7 is a sectional schematic diagram of a partial structure of the flexible air duct of the present invention;

FIG. 8 is a schematic diagram of a partial structure of the air duct positioning assembly of the present invention.

1, inlet air duct, 2, rotating air inlet assembly, 2-1, first connecting flange, 2-2, rotating air duct, 2-3, fixed air duct, 2-4, rolling bearing, 2-5, oil seal, 2-6, bearing positioning pressing plate, 2-7, gas seal ring, 2-8, oil seal pressing plate, 2-9, oil seal pressing plate, 3, mounting platform, 4, bracket, 5, second connecting flange, 6, bearing seat, 7, air duct hoop sleeve, 7-1, connecting plate, 8, flexible air duct, 9, reel body, 9-1, air duct connection port, 9-2, rope slot, 9-3, reel air duct shaft, 9-4, reel air duct interface, 9-5, reel rotating shaft, 9-6, fixed head, 9-7, air inlet slot, 10, bearing seat, 11, hysteresis coupling, 12, rotating drive assembly, 12-1, gear reducer, 12-2, coupling, 12-3, electric motor, 13, steel wire rope, 13-1, rope hoop, 14, steel wire rope fixed end, 15, fixed support, 16, outlet air duct.

### DETAILED DESCRIPTION OF THE EMBODIMENTS

The present invention is described in detail below in combination with the accompanying drawings and a specific embodiment. It should be noted that the following description of the embodiment is merely a substantial illustration, the present invention is not intended to be limited in its application or its use, and the present invention is not limited to the following embodiment.

### EMBODIMENT

In industrial production sites, many sites need to have forced air supply needs, and the locations or facilities that need air supply are always in a motion state, and an air supply device which has an air supply volume reaching 2000 to 10000 cubic meters of air per hour and which can operate continuously for a long time is in need.

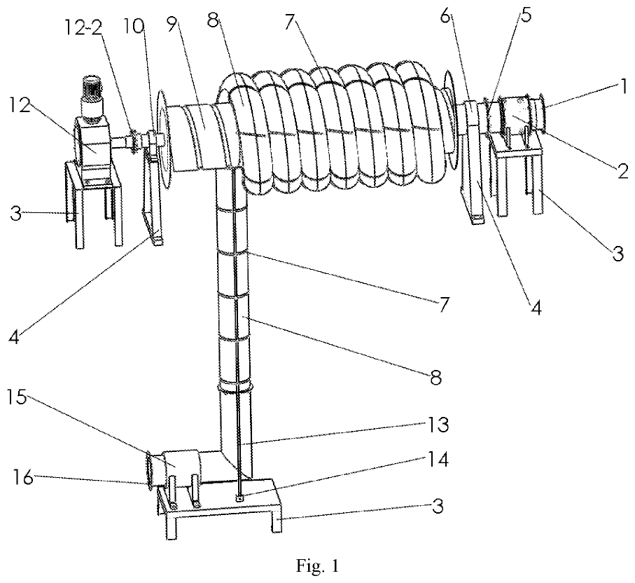

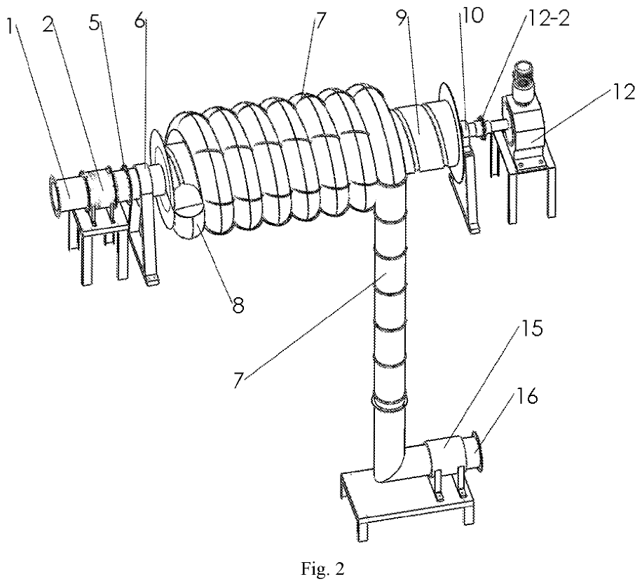

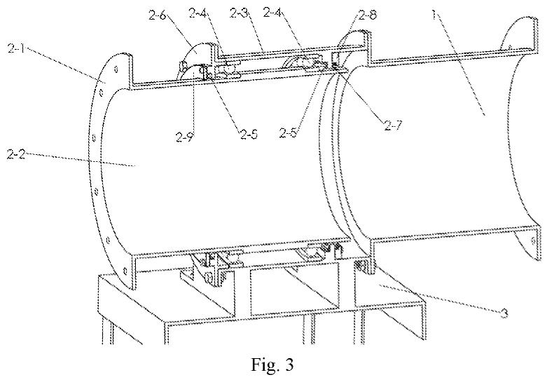

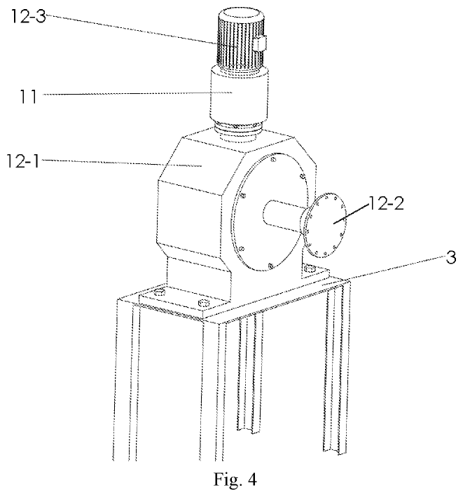

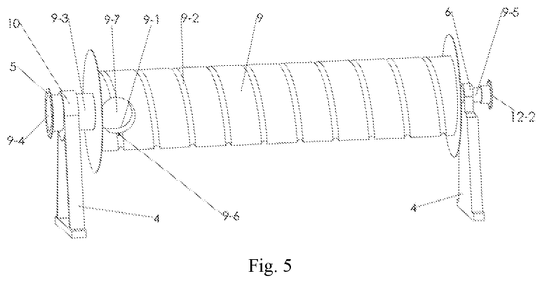

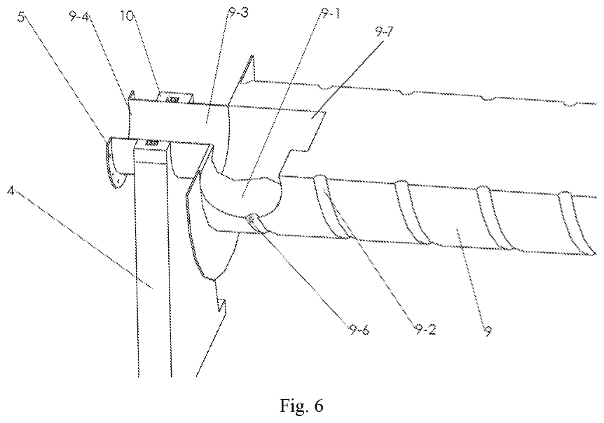

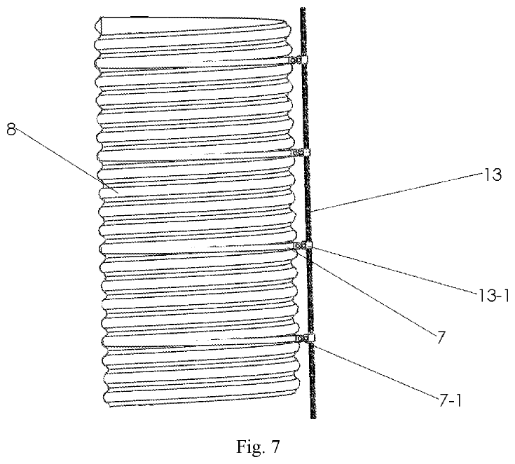

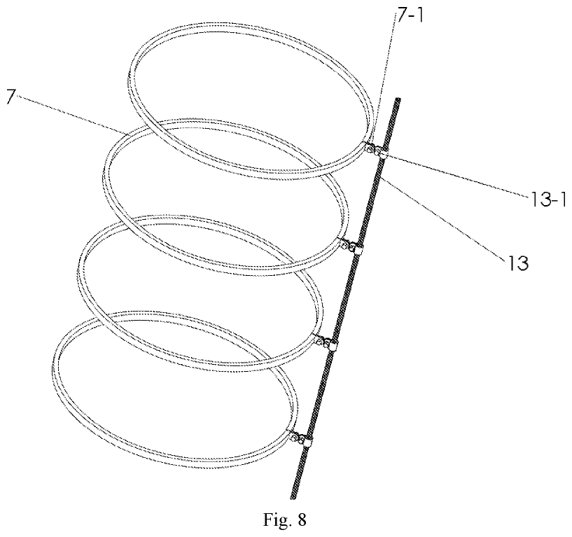

The present embodiment provides a flexible air duct winding and unwinding device for air supply, as shown in FIG. 1 to FIG. 8, including an air duct reel assembly, a flexible air duct 8, two reel seats, a rotating air inlet assembly 2 and a rotating drive assembly 12 for driving the rotation of the air duct reel assembly.

The device is in cooperation with the air supply fan during use, air is fed into the air inlet of the rotating air inlet assembly 2, and is fed into the flexible air duct 8 through an air duct reel assembly, and the air outlet of the flexible air duct 8 is arranged at the locations or facilities that need air supply.

Specifically, in the present embodiment, to satisfy the above requirement, the implementation is described as follows.

The air inlet of the rotating air inlet assembly 2 is connected with an air supply fan, the air outlet is connected with an air duct reel assembly, the rotating air inlet assembly 2 includes an inlet air duct 1, a fixed air duct 2-3 and a rotating air duct 2-2 rotatably inserted in the fixed air duct 2-3, and the air outlet end of the inlet air duct 1 is connected with the air inlet end of the fixed air duct 2-3.

To realize relative rotation of the rotating air duct 2-2 and the fixed air duct 2-3, a plurality of rolling bearings 2-4 are arranged between the rotating air duct 2-2 and the fixed air duct 2-3, and the two sides of the rolling bearings 2-4 are provided with oil seals 2-5 and oil seal pressing plates 2-8. In the present embodiment, two groups of rolling bearings 2-4 are adopted to form the bearing assembly, a positioning pressing plate is arranged on the inner side of the fixed air duct at one side of the bearing assembly, oil seals 2-5 are arranged at the positioning pressing plate, the positioning pressing plate serves as an oil seal pressing plate 2-9 to limit the oil seals 2-5, the other side of the bearing assembly, that is, the tail end face of the fixed air duct 2-3, is provided in sequence with a bearing positioning pressing plate 2-6, an oil seal 2-5 and an oil seal pressing plate 2-9, to limit and perform oil sealing on the rolling bearing 2-4, the bearing positioning pressing plate 2-6, the oil seal pressing plate 2-9 and the fixed air duct 2-3 are connected through bolts and nuts, and the inlet air duct 1 and the fixed air duct 2-3 are connected through bolts and nuts.

In addition, to ensure gas tightness of the gap between the rotating air duct and the fixed air duct 2-3 and prevent leakage of gas, a gas seal ring 2-7 and a gas seal pressing plate 2-8 for fixing the gas seal ring 2-7 are arranged between the circumference of the air inlet end of the rotating air duct 2-2 and the inner side wall of the fixed air duct 2-3, to stop the gas in the pipeline from leaking out of the pipeline from the interface, thereby featuring by wear-resistance, good sealing performance and capability of being replaced.

The flow of air in the rotating air inlet assembly 2 is from the inlet air duct 1 to the fixed air duct 2-3 and then enters into the air duct reel assembly through the rotating air duct 2-2.

The air duct reel assembly includes a reel body 9, a reel air duct shaft 9-3, and a reel rotating shaft 9-5. The reel seat includes a bracket 4 and a bearing seat 10 arranged on the bracket 4.

An end face of one end of the reel body 9 is formed with an air inlet slot 9-7 and is fixedly installed with the reel air duct shaft 9-3, the reel air duct shaft 9-3 is hollow inside to form an air duct and is communicated with the air inlet slot 9-7, the air outlet end of the rotating air duct 2-2 is fixedly connected with the reel air duct shaft 9-3, the flexible air duct 8 is wound on a side wall of the reel body 9, the side wall of the reel body 9 is formed with an air duct connection port 9-1, one end of the air duct connection port 9-1 is communicated with the air inlet slot 9-7, and the other end is communicated with the air inlet of the flexible air duct 8.

A reel air duct interface 9-4 is arranged at the front end of the reel air duct shaft 9-3, a second connecting flange 5 is arranged on the reel air duct interface 9-4, a first connecting flange 2-1 is arranged at the tail end of the rotating air duct 2-2, the rotating air duct 2-2 is fixedly connected with the reel air duct shaft 9-3 through the first connecting flange 2-1 and the second connecting flange 5, and during connection, the requirements that the two tubular parts should be coaxial and sealed should be satisfied.

The above structure realizes air inlet and outlet of the reel body 9, air from the rotating air duct 2-2 enters the reel air duct shaft 9-3, and then enters the flexible air duct 8 through the air inlet slot 9-7 and the air duct connection port 9-1.

The end face of the other end of the reel body 9 is fixedly provided with the reel rotating shaft 9-5, the reel air duct shaft 9-3 is in rotatable connection with a bearing seat 10 on the reel seat, the reel rotating shaft 9-5 is in rotatable connection with the bearing seat 10 on another reel seat, the output shaft of the rotating drive assembly 12 is fixedly connected with the reel rotating shaft 9-5, to realize the rotation of the reel body 9 under the driving of the rotating drive assembly 12.

As to the structure of the rotating drive assembly 12, the rotating drive assembly 12 includes an electric motor 12-3, a gear reducer 12-1 and a coupling 12-2, the output shaft of the electric motor 12-3 is connected with the input end of the gear reducer 12-1, and the output shaft of the gear reducer 12-1 is fixedly connected with the reel rotating shaft 9-5 by means of a coupling 12-2.

To realize the characteristic that the rotating drive assembly 12 has a constant drive torque, the rotating drive assembly 12 further includes a hysteresis coupling 11, and the output shaft of the electric motor 12-3 is connected with the input end of the gear reducer 12-1 through the hysteresis coupling 11.

In the present embodiment, the electric motor 12-3 of the present invention uses a single steering motor, which is always rotating in a single direction when being driven. The gear reducer 12-1 can convert the rotating speed and torque of the single steering motor to the desired rotating speed and torque. The hysteresis coupling 12-2 adopts the magnetic coupling principle, the input shaft and output shaft in the hysteresis coupling can transfer force and torque without direct contact, and the values of the transferred force and torque can be set, when the resistance on the output shaft is less than or equal to the transferred driving force, the hysteresis coupling 12-2 can drive the output shaft to rotate in the same direction, when the resistance on the output shaft is greater than the transferred driving force, the rotating directions of the input shaft and the output shaft of the hysteresis coupling 12-2 are opposite, that is, the output shaft is dragged in an opposite direction. The single steering motor means that the motor has a single rotating direction and cannot be rotated in the reverse direction, and is generally achieved by setting a one-way bearing on the rotating shaft. Under the cooperation of both the hysteresis coupling 12-2 and the single steering motor, the whole set of rotating drive assembly 12 in the present embodiment has a constant driving force and torque in a single rotating direction, and when the rotating drive assembly 12 is in operation, the motor 12-3 is always rotating in a single direction, regardless of whether the output shaft of the gear reducer 12-1 is in forward or reverse rotation or in an idle state.

To facilitate mounting and fixation, the air duct reel assembly further includes two mounting platforms 3, the rotating air inlet assembly 2 is arranged on one mounting platform 3, and the rotating drive assembly 12 is arranged on the other mounting platform 3.

In order to position the flexible air duct 8 when winding and prevent the flexible air duct 8 from being extruded, the reel assembly further includes an air duct positioning assembly, the air duct positioning assembly includes a steel wire rope 13 and a plurality of air duct positioning members, the air duct positioning members are arranged on the steel wire rope 13 at intervals, the air duct positioning members include an air duct hoop sleeve 7, a connecting plate 7-1 and a rope hoop 13-1, the rope hoop 13-1 is fixedly sleeved on the steel wire rope 13, the air duct hoop sleeve 7 is fixedly sleeved on the flexible air duct 8, and one end of the connecting plate 7-1 is fixedly connected with the rope hoop 13-1, and the other end is fixedly connected with the air duct hoop sleeve 7. In cooperation with the structure of the steel wire rope 13, the side wall of the reel body 9 is formed with a rope slot 9-2 for placing the steel wire rope 13, and the initial end of the rope slot 9-2 is provided with a fixed head 9-6, and the fixed head 9-6 is fixedly connected with the initial end of the steel wire rope 13.

Under the positioning of the air duct hoop sleeve 7, the connecting plate 7-1 and the rope hoop 13-1, the flexible air ducts 8 can be effectively prevented from being squeezed or stacked with each other or spaced too far apart, thereby making it impossible for the subsequent flexible air duct 9 to be continuously wound on the reel body 9. Using the fixed head 9-6 and the air duct connection port 9-1, the steel wire rope 13 connected with the flexible air duct 7 can be fixed firmly at one end, and the weight of the flexible air duct 9 can be evenly transferred to the steel wire rope 13 when the flexible air duct is wound and unwound.

In addition, to facilitate fixation and use at the outlet of the flexible air duct 8, the winding and unwinding device further includes an air duct outlet assembly, and the air outlet of the flexible air duct 8 is communicated with the air inlet of the air duct outlet assembly. The air duct outlet assembly includes a fixed platform, an outlet air duct 16 and a fixed support 15, the fixed support 15 is fixedly arranged on the fixed platform, the outlet air duct 16 is fixedly connected with the fixed support 15, and the air inlet of the outlet air duct 16 is communicated with the air outlet of the flexible air duct 8. The fixed platform is provided with a steel wire rope fixed end 14, and the tail end of the steel wire rope 13 is fixedly connected with the steel wire rope fixed end 14.

Operating Principles:

As to the air flow direction of the present invention, the air supply fan feeds air into the inlet air duct 1, and then air passes through the fixed air duct 2-3 and the rotating air duct 2-2 in turn and enters the reel air duct shaft 9-3 of the reel body 9, and passes through the air inlet slot 9-7 and the air duct connection port 9-1 and enters the flexible air duct 8, and then air is transported to the outlet air duct 16 through the flexible air duct 8.

In order to realize the winding storage and unwinding release of the flexible air duct 8 on the reel body 9, the rotating air duct 2-2 and the reel body 9 are driven by the rotating drive assembly 12 to rotate around the axis: the distance between the air inlet end and the air outlet end will be elongated or shortened, and the flexible air duct 8 also needs to be simultaneously elongated or shortened, which is realized by the winding of the flexible air duct: when the distance is increased, the flexible air duct 8 is released from the reel, and when the distance is shortened, the flexible air duct 8 is wound onto the reel body 9. The winding and release of the flexible air duct 8 can fully meet the requirements of the distance change between the air inlet end and the air outlet end.

The rotating drive assembly 12 has a constant torque. When the distance between the air inlet end and the air outlet end is shortened, the torque of the flexible air duct 8 is less than the output torque of the rotating drive assembly 12, and the rotating directions of the input shaft and the output shaft in the hysteresis coupling 12-2 are the same, the rotating drive assembly 12 overcomes the torque on the flexible air duct 8 and the reel body, to drive the reel body to rotate forwardly and drive the reel body 9 to roll the flexible air duct 8 into the reel body 9, so as to meet the shortened distance between the air inlet end and the air outlet end to achieve the winding and unwinding of the flexible air duct 8. When the distance between the air inlet end and the air outlet end wants to be elongated, the distance between the air inlet end and the air outlet end is elongated directly at the output end, and the external torque is greater than the constant torque of the rotating drive assembly 12, the rotating directions of the input shaft and the output shaft in the hysteresis coupling 12-2 will be opposite, to overcome their torque to drive the reel to rotate in an opposite direction, so as to release the flexible air duct 8 and satisfy the distance growth. In order to avoid the tensile force on the flexible air duct 8 in the process of winding and releasing the flexible air duct 8 and to avoid various stresses in the winding process, the steel wire rope 13 is used to fix with the flexible air duct 8, and the steel wire rope 13 will bear these tensile forces to prevent the flexible air duct 8 from directly bearing the traction and tensile force, so as to improve the reliability and prolong the service life of the flexible air duct 8.

Based on the above principle, generally speaking, the single steering motor of the present invention runs continuously, and as to the distance between the outlet air duct 16 and the reel body 9 of the present invention, when the distance is shortened, the reel body 9 is rotating to drive the flexible air duct 8 to be wound up on the reel body 9, so as to achieve storage, and when the distance is constant, the reel body 9 does not rotate, and when the distance is elongated, the flexible air duct 8 is pulled out to drive the reel body 9 to rotate, and the flexible air duct 8 is released from the reel body 9.

The above-mentioned embodiments are merely examples and do not represent a limitation of the scope of the present invention. These embodiments can also be implemented in various other ways, and can be omitted, replaced, and changed within the scope of the technical ideas of the present invention.

We claim:

1. A flexible air duct winding and unwinding device for air supply, comprising an air duct reel assembly, a flexible air duct (8), two reel seats, a rotating air inlet assembly (2) and a rotating drive assembly (12) for driving the rotation of the air duct reel assembly,
the air duct reel assembly comprises a reel body (9), a reel air duct shaft (9-3), and a reel rotating shaft (9-5), wherein an end face of one end of the reel body (9) is formed with an air inlet slot (9-7) and is fixedly installed with the reel air duct shaft (9-3), the reel air duct shaft (9-3) is hollow inside to form an air duct and is communicated with the air inlet slot (9-7), the end face of the other end of the reel body (9) is fixedly provided with the reel rotating shaft (9-5), the reel seat comprises a bracket (4) and a bearing seat (10) arranged on the bracket (4), the reel air duct shaft (9-3) is in rotatable connection with a bearing seat (10) on the reel seat, the reel rotating shaft (9-5) is in rotatable connection with the bearing seat (10) on another reel seat, the flexible air duct (8) is wound on a side wall of the reel body (9), the side wall of the reel body (9) is formed with an air duct connection port (9-1), one end of the air duct connection port (9-1) is communicated with the air inlet slot (9-7), and the other end is communicated with the air inlet of the flexible air duct (8);
the rotating air inlet assembly (2) comprises an inlet air duct (1), a fixed air duct (2-3) and a rotating air duct (2-2) rotatably inserted in the fixed air duct (2-3), wherein the air outlet end of the inlet air duct (1) is connected with the air inlet end of the fixed air duct (2-3), the air outlet end of the rotating air duct (2-2) is fixedly connected with the reel air duct shaft (9-3), and
the output shaft of the rotating drive assembly (12) is fixedly connected with the reel rotating shaft (9-5).

2. The flexible air duct winding and unwinding device for air supply of claim 1, wherein the air duct reel assembly further comprises an air duct positioning assembly, the air duct positioning assembly comprises a steel wire rope (13) and a plurality of air duct positioning members, the air duct positioning members are arranged on the steel wire rope (13) at intervals, the air duct positioning member comprises an air duct hoop sleeve (7), a connecting plate (7-1) and a rope hoop (13-1), the rope hoop (13-1) is fixedly sleeved on the steel wire rope (13), the air duct hoop sleeve (7) is fixedly sleeved on the flexible air duct (8), one end of the connecting plate (7-1) is fixedly connected with the rope hoop (13-1), and the other end is fixedly connected with the air duct hoop sleeve (7).

3. The flexible air duct winding and unwinding device for air supply of claim 2, wherein a side wall of the reel body (9) is formed with a rope slot (9-2) for placing the steel wire rope (13), the initial end of the rope slot (9-2) is provided with a fixed head (9-6), and the fixed head (9-6) is fixedly connected with the initial end of the steel wire rope (13).

4. The flexible air duct winding and unwinding device for air supply of claim 1, wherein the rotating drive assembly (12) comprises an electric motor (12-3), a gear reducer (12-1) and a coupling (12-2), an output shaft of the electric motor (12-3) is connected with an input end of the gear reducer (12-1), and an output shaft of the gear reducer (12-1) is fixedly connected with the reel rotating shaft (9-5) by means of a coupling (12-2).

5. The flexible air duct winding and unwinding device for air supply of claim 4, wherein the rotating drive assembly (12) further comprises a hysteresis coupling (11), and an output shaft of the electric motor (12-3) is connected with an input end of the gear reducer (12-1) by means of the hysteresis coupling (11).

6. The flexible air duct winding and unwinding device for air supply of claim 1, wherein the winding and unwinding device further comprises an air duct outlet assembly, and the air outlet of the flexible air duct (8) is communicated with the air inlet of the air duct outlet assembly.

7. The flexible air duct winding and unwinding device for air supply of claim 6, wherein the air duct outlet assembly comprises a fixed platform, an outlet air duct (16), and a fixed support (15), the fixed support (15) is fixedly arranged on the fixed platform, the outlet air duct (16) is fixedly connected with the fixed support (15), and an air inlet of the outlet air duct (16) is communicated with the air outlet of the flexible air duct (8).

8. The flexible air duct winding and unwinding device for air supply of claim 1, wherein a plurality of rolling bearings (2-4) are arranged between the rotating air duct (2-2) and the fixed air duct (2-3), and the two sides of the rolling bearings (2-4) are provided with oil seals (2-5) and oil seal pressing plates (2-8).

9. The flexible air duct winding and unwinding device for air supply of claim 1, wherein a gas seal ring (2-7) and a gas seal pressing plate (2-8) for fixing the gas seal ring (2-7) are arranged between the circumference of the air inlet end of the rotating air duct (2-2) and the inner side wall of the fixed air duct (2-3).

10. The flexible air duct winding and unwinding device for air supply of claim 1, wherein the air duct reel assembly further comprises two mounting platforms (3), the rotating air inlet assembly (2) is arranged on one mounting platform (3), and the rotating drive assembly (12) is arranged on the other mounting platform (3).
